(19) United States
(12) Patent Application Publication
(10) Pub. No.: US 2023/0306707 A1
(43) Pub. Date: Sep. 28, 2023

(54) AROUND VIEW MONITORING SYSTEM AND THE METHOD THEREOF

(71) Applicant: HL KLEMOVE CORP., Incheon (KR)

(72) Inventor: Taebong NOH, Gyeonggi-do (KR)

(21) Appl. No.: 18/202,289

(22) Filed: May 26, 2023

(30) Foreign Application Priority Data
Mar. 28, 2022 (KR) 10-2022-0038140
Nov. 15, 2022 (KR) 10-2022-0152431

(51) Int. Cl. G06V 10/10; H04N 5/262; H04N 7/18; G06V 20/58; G06V 10/82; G06V 10/24; H04N 23/90; B60R 1/22

(52) U.S. Cl. CPC G06V 10/16; H04N 5/2624; H04N 7/181; G06V 20/58; G06V 10/82; G06V 10/24; H04N 23/90; B60R 1/22; B60R 2300/303; B60R 2300/105; B60R 2300/607

(57) ABSTRACT

An around view monitoring system according to an embodiment of the present disclosure includes a first image processor configured to generate a top view image by stitching a plurality of images received from a plurality of cameras mounted to a vehicle, process the top view image based on a display setting, and control to display the processed top view image on a display; and a second image processor configured to process an image received from at least one camera among the plurality of cameras based on a recognition setting, and detect an object in the processed image.

### CROSS-REFERENCE TO RELATED APPLICATION

The present application claims priority to Korean Patent Application No. 10-2022-0038140 and 10-2022-0152431, filed Mar. 28, 2022 and Nov. 15, 2022 respectively, the entire contents of which is incorporated herein for all purposes by this reference.

### BACKGROUND

### 1. Field of the Invention

The present disclosure relates to an around view monitoring system and an around view monitoring method.

### 2. Discussion of Related Art

An around view monitoring (AVM) system is a system that secures safety and convenience of a driver by using an image captured by a plurality of cameras mounted in various places of a vehicle to show a situation around a host vehicle as a top view image, a 3D view image, and/or each camera image.

The AVM system has expanded its functions and scope to recognize objects around a host vehicle by additionally applying an image recognition algorithm in addition to a function of simply showing a captured image to a driver, and to enable a warning or vehicle control using the recognized result.

Meanwhile, as the number of cameras mounted in a vehicle is increased to provide more convenient services like the AVM system, a signal processing device such as a processor for image signal processing is installed in each camera, which is inefficient in terms of cost.

In addition, image correction of the signal processing device installed in the camera is processed as a criterion suitable for a driver to view, and when an object is to be detected using this image, there is a limitation in object detection performance due to a limitation of an actual image. Therefore, an image for effectively checking a situation around a host vehicle and an image for performing object recognition by a vehicle have different image processing requirements, and thus it is necessary to distinguish and process the image.

As such, there is a need for an image processing method optimized for functions provided by an AVM system while reducing cost.

### SUMMARY OF THE INVENTION

The present disclosure is directed to providing an around view monitoring system and an around view monitoring method that increase user satisfaction while ensuring safety.

An around view monitoring system according to an embodiment of the present disclosure includes a first image processor configured to generate a top view image by stitching a plurality of images received from a plurality of cameras mounted to a vehicle, process the top view image based on a display setting, and control to display the processed top view image on a display; and a second image processor configured to process an image received from at least one camera among the plurality of cameras based on a recognition setting, and detect an object in the processed image.

The first image processor may correct each image based on the display setting before stitching the plurality of images.

The second image processor may detect an object in the image based on a model trained to detect an object in an input image.

The second image processor may extract a correction index according to an image received from the at least one camera and a correction degree of each of the processed images, and inactivate a function of detecting an object in the processed image if the correction index exceeds a predefined value.

The second image processor may transmit a control signal to control at least one of an alarm device and a driving control device according to a detection result.

The display setting may include information about a setting suitable for image display for each of a plurality of correction techniques.

The recognition setting may include information about a setting suitable for object detection for each of a plurality of correction techniques.

The top view image is a first top view image, and the second image processor may generate a second top view image by stitching a plurality of images received from the plurality of cameras, and process the second top view image based on a recognition setting to detect an object in the second top view image.

The plurality of cameras may include a front camera configured to capture a front of the vehicle, a rear camera configured to capture a rear of the vehicle, a left camera configured to capture a left side of the vehicle, and a right camera configured to capture a right side of the vehicle.

An around view monitoring system according to an embodiment of the present disclosure includes a first image processor configured to primarily process a plurality of images received from a plurality of cameras mounted to a vehicle based on a display setting, generate a top view image by stitching the plurality of processed images, secondarily process the top view image based on the display setting, and control to display the processed top view image on a display; and a second image processor configured to process the plurality of processed images or the top view image received from the first image processor based on a recognition setting, and detect an object in the processed image.

The second image processor may determine whether the plurality of processed images or the top view image is suitable for object detection based on the recognition setting, and restore a correction of the plurality of processed images or the top view image if the plurality of processed images or the top view image is not suitable for the object detection.

The second image processor may detect an object in the processed image based on a model trained to detect an object in an input image.

The second image processor may extract a correction index according to a correction degree of each of the plurality of processed images or the top view image received from the first image processor and the processed image, and inactivate a function of detecting an object in the processed image if the correction index exceeds a predefined value.

The second image processor may transmit a control signal to control at least one of an alarm device and a driving control device according to a detection result.

An around view monitoring method performed by an around view monitoring system according to an embodiment of the present disclosure includes generating a top view image by stitching a plurality of images received from a plurality of cameras mounted to a vehicle; processing the top view image based on a display setting and controlling the processed top view image to be displayed on a display; processing an image received from at least one of the plurality of cameras based on a recognition setting; and detecting an object in the processed image.

The method may further include, prior to the generating a top view image, correcting each image based on the display setting.

The detecting an object may include detecting an object in the image based on a model trained to detect an object in an input image.

The detecting an object may include extracting a correction index according to a correction degree of each of an image received from the at least one camera and the processed image; and inactivating a function of detecting an object in the processed image if the correction index exceeds a predefined value.

The method may further include transmitting a control signal to control at least one of an alarm device and a driving control device according to a detection result.

According to an embodiment of the present disclosure, image processing may be performed independently with respect to the around view image display and the object detection to exclude mutual influence. As a result, it is possible to increase service satisfaction of the driver and to ensure driving stability through accurate object detection.

According to an embodiment of the present disclosure, each image processing condition for image display and object detection can be secured to be equally applied regardless of the type of the vehicle, and the same performance can be secured through consistent application from the acquired image.

### BRIEF DESCRIPTION OF THE DRAWINGS

FIG. 1 is a diagram schematically illustrating an AVM system according to an embodiment of the present disclosure.

FIG. 2 is a block diagram illustrating a configuration of a vehicle according to an embodiment of the present disclosure.

FIG. 3 is a flowchart illustrating an operation of an AVM system according to a first embodiment of the present disclosure.

FIG. 4 is a schematic diagram illustrating an operation of an AVM system according to a first embodiment of the present disclosure.

FIG. 5 is a flowchart illustrating an operation of an AVM system according to a second embodiment of the present disclosure.

FIG. 6 is a schematic diagram illustrating an operation of an AVM system according to a second embodiment of the present disclosure.

### DETAILED DESCRIPTION OF EXEMPLARY EMBODIMENTS

Hereinafter, preferred embodiments according to the present disclosure will be described in detail with reference to the accompanying drawings. The detailed description to be disclosed hereinafter with the accompanying drawings is intended to describe exemplary embodiments of the present disclosure and is not intended to represent the only embodiments in which the present disclosure may be implemented. In the drawings, parts unrelated to the description may be omitted for clarity of description of the present disclosure, and like reference numerals may designate like elements throughout the specification. In addition, in the embodiment of the present disclosure, terms including ordinal numbers such as first and second are used only for the purpose of distinguishing one component from another, and expressions in the singular include plural expressions unless the context clearly indicates otherwise.

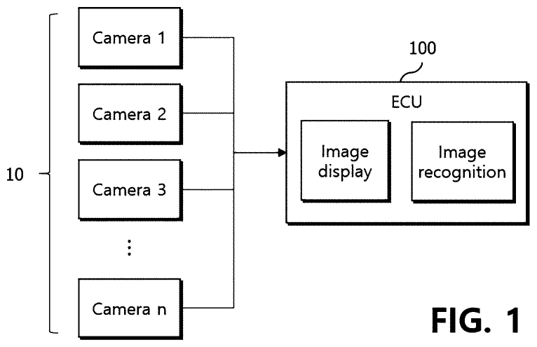

FIG. 1 is a diagram schematically illustrating an AVM system according to an embodiment of the present disclosure.

Referring to FIG. 1, a plurality of cameras (camera 1, camera 2, camera 3, . . . , camera n) 10 and an electronic control unit (ECU) 100 are shown.

According to an embodiment of the present disclosure, the plurality of cameras 10 are mounted to a vehicle to capture an image around the vehicle and transmit the captured image to the ECU 100.

The plurality of cameras 10 may include a front camera configured to capture a front of the vehicle, a rear camera configured to capture a rear of the vehicle, a left camera configured to capture a left side of the vehicle, and a right camera configured to capture a right side of the vehicle. However, the position of the camera mounted to the vehicle or the number of cameras is not limited thereto.

Hereinafter, for convenience of description, it is assumed that the plurality of cameras 10 are four cameras for photographing the front and rear and the left and right sides.

According to an embodiment of the present disclosure, the ECU 100 is configured to process images received from the plurality of cameras 10 to provide an image display function and an image recognition function, and may be implemented as a processor.

Meanwhile, as described above, the plurality of cameras 10 may include a processor for processing images, but a cost burden is incurred when each camera is individually equipped with a processor.

In addition, in order to apply the image processed by the camera to the actual function, additional processing is required, and thus the image processing may be performed in dual ways, which may be inefficient, and images provided for different functions need to be integrated and managed in order for the images to be processed according to each function.

Therefore, the present disclosure proposes a technology for integrally managing images received from a plurality of cameras 10 in the ECU 100 and separately processing an image for showing to a driver and an image for detecting an object.

Hereinafter, a configuration and an operation of a vehicle according to an embodiment of the present disclosure will be described in detail with reference to the drawings.

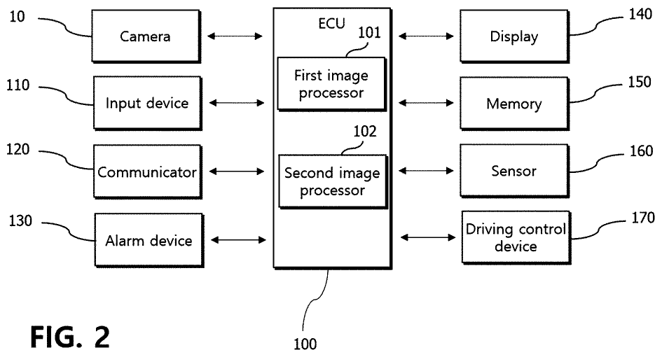

FIG. 2 is a block diagram illustrating a configuration of a vehicle according to an embodiment of the present disclosure.

The vehicle according to an embodiment of the present disclosure includes a plurality of cameras 10, an ECU 100, an input device 110, a communicator 120, an alarm device 130, a display 140, a memory 150, a sensor 160, and a driving control device 170.

The ECU 100 may execute software, such as a program, to control at least one other component (e.g., hardware or software component) of the vehicle, and may perform various data processing or computations.

According to an embodiment of the present disclosure, the ECU 100 may include a first image processor 101 for processing an image to be shown to a driver and a second image processor 102 for processing an image for object detection. Specifically, the first image processor 101 may stitch a plurality of images received from the plurality of cameras 10 mounted to the vehicle to generate a top view image, process the top view image based on a display setting, and control the processed top view image to be displayed on the display. The second image processor 102 may process the image received from at least one of the plurality of cameras 10 based on a recognition setting, and detect an object in the processed image.

According to an embodiment of the present disclosure, the first image processor 101 and the second image processor 102 may be implemented separately by separate hardware, but are not limited thereto, and may be implemented as one processor but may be described separately as image processing for different functions.

According to an embodiment of the present disclosure, the first image processor 101 may be implemented as an image signal processor, and may perform operations such as deblurring in each block through a modularized signal processing block, distortion correction, white balancing, demosaicing, color transform, gamma encoding, anti-aliasing, removing artifacts such as noise, and the like, or adjusting illuminance, chroma, and the like.

According to an embodiment of the present disclosure, the second image processor 102 may be implemented as an image optimizer based on deep learning, and may detect an object in an image based on a model (hereinafter, referred to as a detection model) trained to detect an object in an input image.

In addition to this, the ECU 100 may perform overall control of the vehicle such as braking control, driving control, and alarm control by using sensors mounted to the vehicle such as a pedal travel sensor (PTS), a motor position sensor (MPS), and a wheel steering sensor (WSS), and components mounted to the vehicle such as a motor and a brake system.

Meanwhile, the ECU 100 may perform at least some of the data analysis, processing, and result information generation for performing the above operations using at least one of machine learning, a neural network, and a deep learning algorithm as a rule-based or artificial intelligence algorithm. Examples of the neural network may include a model such as a deep convolutional neural network (DCNN), a convolutional neural network (CNN), a deep neural network (DNN), a recurrent neural network (RNN), and a generative adversarial networks (GAN).

The input device 110 generates input data in response to a user input. For example, the user input may be a user input for turning on or off the start of the vehicle, a user input for operating the AVM system, and the like, and may be applied to a case of detecting an object without limitation.

The input device 110 includes at least one input means. The input device 110 may include a dome switch, a touch panel, a touch key, a menu button, and the like.

The communicator 120 receives an image captured from the plurality of cameras or performs communication with an external device. To this end, the communicator 120 may perform wireless communication such as 5th generation communication (5G), long term evolution-advanced (LTE-A), long term evolution (LTE), and wireless fidelity (Wi-Fi), or wired communication such as CAN communication, LIN communication, a local area network (LAN), a wide area network (WAN), and power line communication.

The alarm device 130 is a device that issues an alarm when an alarm is required, such as when an object within a driving range is detected according to the operation of the ECU 100, and may include, for example, a speaker, a sensor installed inside and outside the vehicle, an instrument panel, an internal display of the vehicle, or the like. In addition, the alarm device 130 may be applied without limitation as long as it is an audible and visual alarm device such as a warning sound and a warning message.

The display 140 displays display data according to the operation of the ECU 100. The display 140 may display a screen for displaying a processed image, a screen for displaying a warning message, a screen for receiving a user input, and the like.

The display 140 includes a liquid crystal display (LCD), a light emitting diode (LED) display, an organic light emitting diode (OLED) display, a micro electro mechanical systems (MEMS) display, and an electronic paper display. The display 140 may be combined with the input device 110 to be implemented as a touch screen.

The memory 150 stores operation programs of the ECU 100. The memory 150 includes a non-volatile storage for storing data (information) regardless of whether power is supplied or not, and a volatile memory in which data to be processed by the ECU 100 is loaded and cannot retain data unless power is provided. The storage includes a flash memory, a hard-disc drive (HDD), a solid-state drive (SSD), a read only memory (ROM), and the like, and the memory includes a buffer and a random access memory (RAM), and the like.

The memory 150 may store an image received from the plurality of cameras 10, a top view image generated by the ECU 100, an image processed by the ECU 100, a detection model for detecting an object, and the like, or a computation program required in a process of performing image stitching, image processing, object detecting, learning of the detection model, and the like.

The sensor 170 refers to all sensors mounted to the vehicle, and may detect vehicle information and transmit the detected vehicle information to the ECU 100. The sensor 170 may be, for example, a PTS, an MPS, a WSS, a steering angle sensor, a temperature sensor, a current sensor, and the like, but is not limited thereto.

The driving control device 170 may include a driving device for driving the vehicle, a braking device for braking the vehicle, a steering device for controlling a driving direction of the vehicle, and the like. The driving control device 170 may receive a control signal for controlling driving from the ECU 100 to control a motor, a brake, a wheel, and the like.

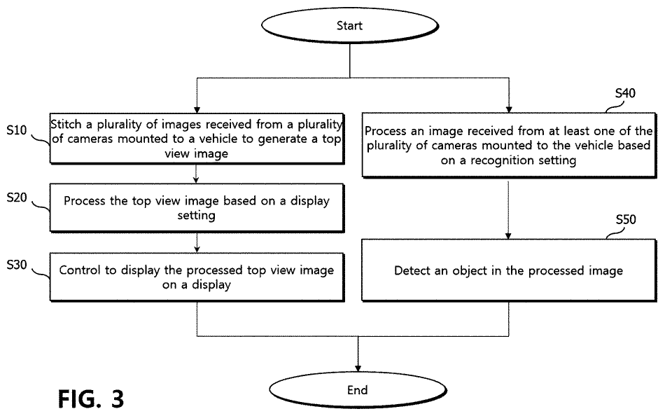

FIG. 3 is a flowchart illustrating an operation of an AVM system according to a first embodiment of the present disclosure.

According to an embodiment of the present disclosure, the ECU 100 may perform operations (S10 to S30) of processing an image displayed on a display through the first image processor 101, respectively, and operations (S40 to S50) of processing an image detecting an object through the second image processor 102. However, each operation may be performed alternately or in parallel according to circumstances.

According to an embodiment of the present disclosure, the first image processor 101 may stitch a plurality of images received from the plurality of cameras 10 mounted to the vehicle to generate a top view image at step S10.

The top view image is a bird-eye view image that looks down to the surrounding environment of the vehicle from above the vehicle, and the first image processor 101 may receive an image from each camera and generate a top view image by connecting the received plurality of images.

In this case, the first image processor 101 may cut an image or perform correction such as reduction/expansion as necessary in a process of stitching images.

According to an embodiment of the present disclosure, the first image processor 101 may process a top view image (also referred to as a first top view image) based on a display setting at step S20.

According to an embodiment of the present disclosure, the display setting refers to a condition for processing an image so that an optimized image can be displayed when the driver views the image with his/her eyes. The display setting may be set according to various situations, such as each time, each place, and each weather, and may be set according to each correction technique.

The display setting may be pre-arranged and stored in the memory 150 in the form of files through various tests and verifications, and certain conditions may be implemented to be adjustable by receiving a user input through a display having a touch screen.

According to an embodiment of the present disclosure, the ECU 100 may collect information from various sensors 160 in a process of identifying a setting suitable for processing an image during a display setting.

In this case, since the first top view image is a combination of separately captured images, chroma, illuminance, and the like may be different depending on the surrounding environment in which each camera is installed. Therefore, the stitched images may be processed according to the display setting.

According to an embodiment of the present disclosure, processing images generally refers to operations such as performing image correction such as image deblurring, distortion correction, white balancing, demosaicing, color transform, gamma encoding, anti-aliasing, removing artifacts such as noise, and the like, or adjusting illuminance, chroma, and the like, in addition to stitching the images received from the plurality of cameras 10 to generate a top view image. Hereinafter, an operation of processing an image by the second image processor 102 is also used in the same meaning.

Also, in this process, the first image processor 101 may correct each image based on a display setting before stitching the plurality of images.

According to an embodiment of the present disclosure, the first image processor 101 may control the processed first top view image to be displayed on the display at step S30.

In this case, the first image processor 101 may control not only the top view image but also the front image, the rear image, and the left/right lateral image to be displayed on the display individually according to the situation.

According to an embodiment of the present disclosure, the second image processor 102 may process an image received from at least one of the plurality of cameras 10 based on a recognition setting at step S40.

The recognition setting according to an embodiment of the present disclosure refers to a condition that the second image processor 102 processes an image so as to detect an optimized image when detecting an object such as a person or an object from the image.

Like the display setting, the recognition setting may be set according to various situations, such as each time, each place, and each weather, and may be set according to each correction technique.

The recognition setting may be pre-arranged and stored in the memory 150 in the form of files through various tests and verifications, and certain conditions may be implemented to be adjustable by receiving a user input through a display having a touch screen.

According to an embodiment of the present disclosure, the ECU 100 may collect information from various sensors 160 in a process of identifying a setting suitable for processing an image during a recognition setting.

According to an embodiment of the present disclosure, the second image processor 102 may stitch a plurality of images received from the plurality of cameras 10 to generate a top view image (also referred to as a second top view image).

Since the top view image is a combination of separately captured images, chroma, illuminance, and the like may be different depending on the surrounding environment in which each camera is installed. Therefore, the stitched images may be processed according to the recognition setting.

According to an embodiment of the present disclosure, the second image processor 102 may detect an object in the processed image at step S50.

The second image processor 102 may detect an object in the processed image or in the second top view image based on a detection model trained to detect an object in an input image. In this case, the process of learning the detection model or the like does not limit the present disclosure.

Meanwhile, the second image processor 102 may excessively correct an image in a process of preprocessing the image for detecting an object. In the case of detecting an object using an excessively corrected image, mishaps may occur, such as falsely detecting that an object does not exist even though it exists, or an error in detecting the size or distance of an object.

Therefore, in order to prevent this, the second image processor 102 may extract a correction index according to a correction degree of each of an image received from at least one camera and a processed image. The correction index may be a correction ratio between the input image and the output image.

If the correction index exceeds a predefined value, the second image processor 102 may deactivate a function of detecting an object in the processed image, or take action such as restoring the image to a pre-correction state. Additionally, the second image processor 102 may notify the driver that the image input is not valid through the alarm device 130 or the display 140.

The second image processor 102 may transmit a control signal to control at least one of the alarm device 130 and the driving control device 170 according to the detection result.

According to an embodiment of the present disclosure, image processing may be performed independently with respect to the around view image display and the object detection to exclude mutual influence. As a result, it is possible to increase service satisfaction of the driver and to ensure driving stability through accurate object detection.

According to an embodiment of the present disclosure, each image processing condition for image display and object detection can be secured to be equally applied regardless of the type of the vehicle, and the same performance can be secured through consistent application from the acquired image.

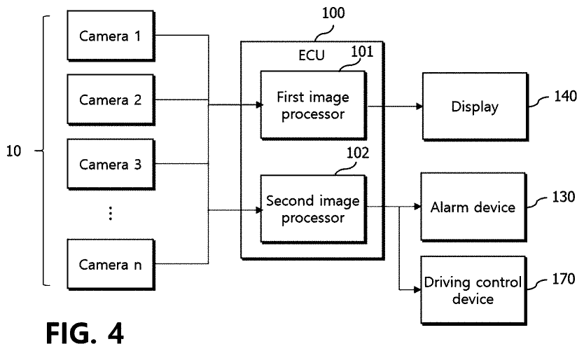

FIG. 4 is a schematic diagram illustrating an operation of an AVM system according to a first embodiment of the present disclosure.

FIG. 4 illustrates an operation of the AVM system of the first embodiment, described with reference to FIG. 3, and the parts of FIG. 3 will be cited with respect to the above-described descriptions.

Referring to FIG. 4, the first image processor 101 and the second image processor 102 of the ECU 100 may receive a plurality of images captured from the plurality of cameras 10 and process the plurality of images based on a display setting and a recognition setting, respectively.

The image processed by the first image processor 101 may be transmitted to the display 140, and the image processed by the second image processor 102 may be transmitted to the alarm device 130 and the driving control device 140 to be controlled for display, alarm, and driving.

According to an embodiment of the present disclosure, since each image processor operates separately, an image processing speed may be increased, and each performance may be optimally implemented.

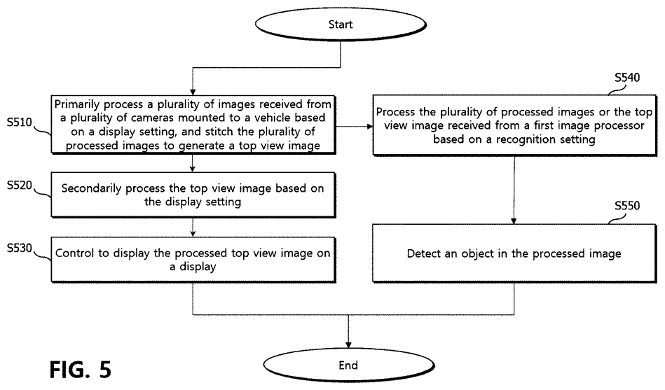

FIG. 5 is a flowchart illustrating an operation of an AVM system according to a second embodiment of the present disclosure.

In this embodiment, a case in which an image processed in the first image processor 101 is shared with the second image processor 102, unlike the first embodiment, described with reference to FIGS. 3 and 4, will be described. The image processing conditions required by the first image processor 101 and the second image processor 102 may be partially matched, and image processing according to a basic image processing technique may be duplicated. Therefore, the first image processor 101 basically process an image and transmits it to the second image processor 102 to reduce dual image processing and reduce time and amount of computation.

Therefore, in the second embodiment, most of the descriptions described with reference to FIG. 3 may be employed, except for a configuration in which the first image processor 101 primarily processes an image and transmits it to the second image processor 102.

According to an embodiment of the present disclosure, the first image processor 101 may primarily process a plurality of images received from a plurality of cameras 10 mounted to a vehicle based on a display setting, and may stitch the plurality of processed images to generate a top view image at step S510.

Similarly, the primarily processable display settings may be previously provided through various tests and verifications and may be stored in a file form in the memory 150, and may be separately provided with some of the previously provided display settings.

The first image processor 101 may secondarily process the top view image based on the display setting at step S520, and may control the processed top view image to be displayed on the display at step S530.

The second image processor 102 may receive the primarily processed plurality of images or the generated top view image, and may process them based on the recognition setting at step S540.

As described above, the second image processor 102 may also detect an object through the top view image, and may receive not only the primarily processed plurality of images but also the top view image generated using the primarily processed plurality of images.

However, in this case, the second image processor 102 may determine whether the plurality of processed images or the top view image is suitable for object detection based on the recognition setting. In preparation for a case in which the recognition setting and the display setting are not perfectly identical, it is necessary to verify once more whether the image is suitable for object detection.

If the images received from the first image processor 101 are not suitable for object detection, the second image processor 102 may restore a correction of the plurality of processed images or the top view image.

The second image processor 102 may detect an object in the processed image at step S550.

The second image processor 102 may detect an object in the processed image based on a model trained to detect an object in an input image. The second image processor 102 may extract a correction index according to a correction degree of each of the plurality of processed images or the top view image received from the first image processor 101 and the image processed by the second image processor 102, and may deactivate a function of detecting an object in the processed image if the correction index exceeds a predefined value.

This is to prevent a case in which the primarily processed images received from the first image processor 102 are overcorrected during a correction process for object detection.

According to an embodiment of the present disclosure, image processing may be performed independently with respect to the around view image display and the object detection, and some overlapping image processing may be performed together to reduce the burden of image processing speed or a computation amount.

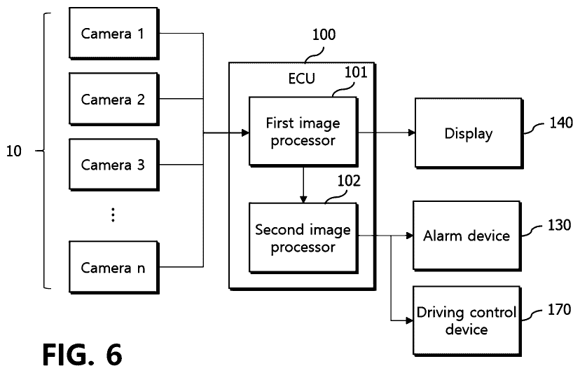

FIG. 6 is a schematic diagram illustrating an operation of an AVM system according to a second embodiment of the present disclosure.

FIG. 6 illustrates an operation of the AVM system of the second embodiment described with reference to FIG. 5, and the parts of FIG. 5 will be cited with respect to the above-described descriptions.

Referring to FIG. 6, the first image processor 101 of the ECU 100 may receive a plurality of images captured by each of the plurality of cameras 10 and primarily process the plurality of images based on a display setting.

The first image processor 101 may transmit the primarily processed plurality of images and the top view image generated using the same to the second image processor 102.

The first image processor 101 may secondarily process the top view image based on the display setting and then transmit the secondarily processed image to the display 140, and the second image processor 102 may secondarily process the image received from the first image processor 101 based on the recognition setting and then transmit the secondarily processed image to the alarm device 130 and the driving control device 140.

According to an embodiment of the present disclosure, each image processor may optimally implement each performance and some overlapping operations may be omitted, thereby increasing the image processing speed.

What is claimed is:

1. An around view monitoring system, comprising:
a first image processor configured to generate a top view image by stitching a plurality of images received from a plurality of cameras mounted to a vehicle, process the top view image based on a display setting, and control to display the processed top view image on a display; and
a second image processor configured to process an image received from at least one camera among the plurality of cameras based on a recognition setting, and detect an object in the processed image.

2. The around view monitoring system of claim 1, wherein the first image processor is configured to correct each image based on the display setting before stitching the plurality of images.

3. The around view monitoring system of claim 1, wherein the second image processor is configured to detect the object in the image based on a model trained to detect an object in an input image.

4. The around view monitoring system of claim 3, wherein the second image processor is configured to:
extract a correction index according to the image received from the at least one camera and a correction degree of each of the processed images, and
inactivate a function of detecting the object in the processed image if the correction index exceeds a predefined value.

5. The around view monitoring system of claim 1, wherein the second image processor is configured to transmit a control signal to control at least one of an alarm device and a driving control device according to a detection result.

6. The around view monitoring system of claim 1, wherein the display setting comprises information about a setting suitable for image display for each of a plurality of correction techniques.

7. The around view monitoring system of claim 1, wherein the recognition setting comprises information about a setting suitable for object detection for each of a plurality of correction techniques.

8. The around view monitoring system of claim 1, wherein:
the top view image is a first top view image, and
the second image processor is configured to:
generate a second top view image by stitching the plurality of images received from the plurality of cameras, and
process the second top view image based on a recognition setting to detect an object in the second top view image.

9. The around view monitoring system of claim 1, wherein the plurality of cameras comprises a front camera configured to capture a front of the vehicle, a rear camera configured to capture a rear of the vehicle, a left camera configured to capture a left side of the vehicle, and a right camera configured to capture a right side of the vehicle.

10. An around view monitoring system, comprising:
a first image processor configured to primarily process a plurality of images received from a plurality of cameras mounted to a vehicle based on a display setting, generate a top view image by stitching the plurality of processed images, secondarily process the top view image based on the display setting, and control to display the processed top view image on a display; and
a second image processor configured to process the plurality of processed images or the top view image received from the first image processor based on a recognition setting, and detect an object in the processed image.

11. The around view monitoring system of claim 10, wherein the second image processor is configured to determine whether the plurality of processed images or the top view image is suitable for object detection based on the recognition setting, and restore a correction of the plurality of processed images or the top view image if the plurality of processed images or the top view image is not suitable for the object detection.

12. The around view monitoring system of claim 10, wherein the second image processor is configured to detect the object in the processed image based on a model trained to detect an object in an input image.

13. The around view monitoring system of claim 12, wherein the second image processor is configured to:
extract a correction index according to a correction degree of each of the plurality of processed images or the top view image received from the first image processor and the processed image, and
inactivate a function of detecting the object in the processed image if the correction index exceeds a predefined value.

14. The around view monitoring system of claim 10, wherein the second image processor is configured to transmit a control signal to control at least one of an alarm device and a driving control device according to a detection result.

15. An around view monitoring method performed by an around view monitoring system, comprising:
generating a top view image by stitching a plurality of images received from a plurality of cameras mounted to a vehicle;
processing the top view image based on a display setting and controlling the processed top view image to be displayed on a display;
processing an image received from at least one of the plurality of cameras based on a recognition setting; and
detecting an object in the processed image.

16. The around view monitoring method of claim 15, further comprising:
prior to the generating a top view image, correcting each image based on the display setting.

17. The around view monitoring method of claim 15, wherein the detecting the object comprises detecting the object in the image based on a model trained to detect an object in an input image.

18. The around view monitoring method of claim 17, wherein the detecting an object comprises:
extracting a correction index according to a correction degree of each of an image received from the at least one camera and the processed image; and
inactivating a function of detecting an object in the processed image if the correction index exceeds a predefined value.

19. The around view monitoring method of claim 15, further comprising transmitting a control signal to control at least one of an alarm device and a driving control device according to a detection result.

20. The around view monitoring method of claim 15, wherein:
the display setting comprises information about a setting suitable for image display for each of a plurality of correction techniques, and
the recognition setting comprises information about a setting suitable for object detection for each of a plurality of correction techniques.
